(19) United States
(12) Patent Application Publication
(10) Pub. No.: US 2006/0199530 A1
(43) Pub. Date: Sep. 7, 2006

(54) Optimal relay node selecting method and multi-hop radio communications network system

(75) Inventor: Daisuke Kawasaki, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/367,320

(22) Filed: Mar. 6, 2006

(30) Foreign Application Priority Data
Mar. 4, 2005 (JP) 2005-061025

(51) Int. Cl. H04B 3/36

(52) U.S. Cl. 455/7

(57) ABSTRACT

A method of selecting an optimal relay node in a multi-hop radio communications network has the steps of receiving, at a particular node, detection response signals which are transmitted from a plurality of other nodes, each of which has received a detection signal, and are not addressed to the particular node, and selecting a relay node based on the received detection response signals. The detection response signal includes, for example, an actual parameter in a node which transmits the detection response signal, and an optimum parameter for use as a criterion for establishing a path. The particular node selects the relay node from among those nodes which have transmitted the detection response signals each having the actual parameter equal to or larger than the optimum parameter.

### BACKGROUND OF THE INVENTION

1. Field of the Invention

The present invention relates to multi-hop radio communications, and more particularly, to a method of selecting optimal relay nodes when a data transfer path is routed in a multi-hop radio communications network, and a multi-hop radio communications network to which such an optimal relay node selecting method is applied.

2. Description of the Related Art:

In a network based on multi-hop radio communications, a plurality of nodes are distributed within a network area, and when a radio link cannot be established for directly connecting a source node to a destination node to transmit data over the air from the source node to the destination node, one or a plurality of relay nodes are interposed between the source node and the destination node to transmit the data over the air from the source node to the destination node while relaying the data from one relay node to another. In the multi-hop radio communication, since at least some of nodes can change in position and state, it is not appropriate to definitively determine a data transfer path from a source node to a destination node through relay nodes, but a data transfer path is required to be dynamically routed through selection of optimal relay nodes.

JP-A-2003-24993, for example, discloses a method of routing a data transfer path in multi-hop radio communications in consideration of a link state between nodes, wherein two modes, i.e., a beacon mode and a path search mode are used to select and route an optimal path between nodes. In the beacon mode, each node transmits and receives beacon packets to exchange information with adjacent nodes to detect the adjacent nodes. Here, the adjacent node refers to a node with which a radio link can be directly established, as viewed from a certain node. In the path search mode, when a beacon packet received at a certain node from an adjacent node includes information on a node which is not adjacent to the receiving node, a path search packet is transmitted to that node, not adjacent, and a searched node determines an optimal path after receiving the path search packet, and transmits a path notification packet to a source node of the path search packet using the optimal path, thereby establishing a path to a remote node. The remote node refers to a node which is not an adjacent node. The establishment of a path to a remote node entails a “path policy,” i.e., a policy for routing a path, which relies on “signal intensity priority” for selecting a path on which radiowaves can be received at a high intensity between nodes, and “lifetime priority” for selecting a transfer path which permits adjacent nodes to continuously operate for a longer period, i.e., a transfer path which will be re-routed at least possible frequencies. The most optimal multi-hop data transfer path is routed in conformity to one of these policies. However, in the method described in JP-A-2003-249636, since each node exchanges information with all adjacent nodes in the beacon mode, this method implies problems of collisions and retransmission of packets, increased power consumption and the like. In the path search mode, in turn, an optimal path is selected by distributing a message to all paths that can be thought, so that a sequence of many processing steps are required for this purpose. Therefore, the method described in JP-A-2003-249936 requires much processing before an optimal path is determined and routed in accordance with the path policy, thus suffering from a low efficiency.

JP-A-2003-258697 proposes an approach for use by a certain node to transmit data to a destination node. In the proposed approach, wherein the node first transmits a pilot signal to find a sum total of transmission power to the destination node, including portions associated with relay nodes, and to simultaneously establish several paths, and selects the one path presenting the smallest sum total of transmission power from the established several paths as an optimal path for use in data transfer. However, with this method, possibly optimal relay nodes can be excluded from candidates for selection Specifically, in this method, a pilot signal is transmitted from a source node to a destination node, and the destination node determines, from the received pilot signal, an optimal path which presents the smallest sum total of transmission power, including that of relay nodes. The destination node receives the pilot signal at a time which should fall within a fixed time period set by a built-in timer from the time the pilot signal was first received, so that if a pilot signal which has passed through an optimal path arrives out of the fixed time, the destination node can fail to receive the pilot signal. On the other hand, for reducing the probability of failing to receive the pilot signal which has passed through an optimal path, a longer time period may be set by the built-in timer, in which case, however, a longer time will be taken until an optimal path is routed.

JP-A-2001-292089 discloses a path selecting method in a multi-hop radio communications network which comprises a control station, base stations arranged in a tree-shaped layered configuration with the control station located at the root, and mobile radio terminals for making communications through the base stations. In the disclosed method, an optimal path is selected by using a delay time and a radio reception intensity as parameters when a mobile radio terminal remains in connection with a plurality of arbitrary base stations. Specifically, higher-level stations within the tree-shaped network configuration hold all incoming transmission data within a standby period (i.e., waiting period) as reception field information, and compares all the held reception field intensities with one another to determine the transmission path which presents the highest reception field intensity among them as a relay path. Also, when transmission data newly arrives, the reception field intensity of the newly arriving data is compared with the reception field intensity of the previously selected path, and a path of the newly arriving transmission data is selected if it presents a higher reception field intensity.

However, this approach can only find an optimal path in a fixed tree-shaped network which has been previously established, and cannot be applied to optimal network routing when the network itself is dynamically configured.

Further, in spite of the fact that in a certain type of multi-hop radio communications network, almost nodes except for a control station are driven by batteries, any of conventional path routing methods does not route a path in consideration of the remaining battery levels or remaining battery amounts in the nodes.

As described above, the conventional relay node selecting methods in multi-hop radio communications networks suffer from such problems as a large number of processing steps which require a long time and high power consumption, a failure in selecting an optimal path, and a failure in supporting a dynamic configuration of a network itself.

### SUMMARY OF THE INVENTION

It is an object of the present invention to provide an optimal relay node selecting method which is capable of efficiently finding an optimal transmission path in any case without fail, while requiring a smaller number of processing steps, in the routing of a data transfer path in a multi-hop radio communications network.

It is another object of the present invention to provide a multi-hop radio communications network system to which the optimal relay node selecting method can be applied for efficiently finding an optimal transmission path in any case without fail, while requiring a smaller number of processing steps.

According to a first aspect of the present invention, an optimal relay node selecting method is a method of selecting an optimal relay node in a multi-hop radio communications network, and includes the steps of receiving, at a particular node, detection response signals which are transmitted from a plurality of other nodes, each of which has received a detection signal, and are not addressed to the particular node, and selecting a relay node based on the received detection response signals.

In this method, the particular node receives the detection response signals transmitted from other nodes even if the particular node has not been detected, and determines an optimal relay node based on the received signals. In this event, the particular node preferably holds therein information relating to the selected optimal relay node.

According to a second aspect of the present invention, an optimal relay node selecting method is a method of selecting an optimal relay node in a multi-hop radio communications network, and includes the steps of receiving, at a particular node, detection response signals which are transmitted from a plurality of other nodes, each of which has received a detection signal, and are not addressed to the particular node, preliminarily selecting a relay node for the particular node based on the received detection response signals, receiving a detection signal for detecting the particular node, selecting an optimal node by comparing a node which has transmitted the detection signal for the particular node with the preliminarily selected relay node, and notifying a higher-level node or base node of the selected optimal relay node.

In this method, when the particular node is detected, the particular node compares a detecting node which detects the particular node with the relay node which is previously held in the particular node. Then the particular node selects a more optimal one for an optimal relay node base on the comparison result, and notifies a higher-level node or base node of the selected optimal relay node, for example, included in a detection response signal. Preferably, the base node subsequently establishes a path between the optimal relay node and the notifying node based on the notified optimal relay node information.

The base node refers to a node which serves as a base station in a multi-hop radio communications network, or a node for conducting centralized control for the multi-hop radio communications network. Of course, the base node may conduct the centralized control for a multi-hop radio communications network and also function as a base station for individual nodes distributed within the network. Therefore, the base node may be called the “centralized control unit/base station.”

In the present invention, each of distributed nodes, when receiving a detection signal from a detecting node, transmits a detection response signal to the detecting node to establish a path. A node which is a target of detection is referred to as In this event, when another node which is not a detected node can receive a detection response signal transmitted by the detected node, the other node determines an optimal relay node for the node itself based on the detection response signal, and holds information on the optimal relay node. Here, “detected node” means a target node of the detection. When a node which is not a detected node receives a plurality of detection response signals from a plurality of nodes, the node selects one optimal relay node from those nodes which have transmitted the detection response signals (i.e., detected nodes) based on the detection response signals, and holds information on the selected optimal relay node. When the node, which has not been a detected node, is detected, the node notifies the centralized control unit that the node itself has been detected and of optimal relay node information of the node itself through the detecting node. Upon receipt of the notification, the centralized control unit forces the optimal relay node to detect the node which has notified the optimal relay node information to route an optimal path.

When the first detecting node is the same as the notified optimal relay node, the same detection is preferably not performed. Criteria for determining an optimal relay node can be a radio reception intensity, a remaining battery level in a relay node, the number of hops of the relay node, and the like, but are not so limited. In regard to the optimal relay node information, rather than holding and notifying information only on one node, information on a plurality of nodes may be held and notified, for example, in the order of priorities given to relay node candidates.

A multi-hop radio communications network system of the present invention includes a base node and a plurality of nodes. Each of the nodes, that is, a target node, includes means for receiving detection response signals which are transmitted from a plurality of other nodes, each of which has received a detection signal, and are not addressed to the target node, and receiving a detection signal for detecting the target node, means for preliminarily selecting a relay node for the target node based on the received detection response signals, and selecting an optimal node by comparing a node which has transmitted the detection signal for detecting the target node with the preliminarily selected relay node, and means for notifying a higher-level node or base node of the selected optimal relay node. The base node includes means for transmitting the detection signal to the plurality of nodes, and sends the detection signal to the optimal relay node, when it is notified of the optimal relay node, to force the optimal relay node to detect the notifying node to route an optimal multi-hop radio communications path.

According to the present invention, even when a target node is not detected, the target node can select an optimal relay node based on received detection response signals addressed to other nodes, thereby making it possible to efficiently select an optimal relay node with a less number of processing steps and to route an optimal path. Further, in the present invention, the target node holds information on the optimal relay node, such that the target node, when detected, notifies the centralized control unit of the information on the optimal relay node for the target node, as included in a detection response signal, thereby enabling the centralized control unit to simultaneously detect the target node and be notified of the optimal relay node. Therefore, an optimal path can be efficiently routed with a less number of processing steps even in regard to the overall network.

According to the present invention, when a multi-hop radio communications system is in a tree-shaped topology including a control station, a base station and the like, the topology of the tree can be dynamically changed in accordance with an optimal path. When a detecting node is different from a notified optimal relay node, an optimal path can be routed from the optimal relay node by additionally detecting the notifying node only once.

Further, in the present invention, since a target node can select an optimal relay node based on the detection response signals received from all upstream nodes located within a range in which such signals can be received over the air, an optimal relay node can be selected without fail from among all possible upstream nodes which can be selected for a relay node of the target node.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a diagram for describing an optimal relay node selecting method in routing a multi-hop radio communications path according to an embodiment of the present invention;

FIG. 2 is a diagram showing exemplary frame formats for radio signals which are communicated between a base node and a node and between nodes;

FIG. 3 is a block diagram illustrating an exemplary configuration of the node;

FIG. 4 is a block diagram illustrating the logical configuration of a CPU;

FIG. 5 is a diagram showing data which is written into and read from a memory;

FIG. 6A is a flow chart illustrating an optimal relay node selecting procedure in the embodiment;

FIG. 6B is a flow chart illustrating in detail a process which is executed when a detection signal is received in the procedure illustrated in FIG. 6A;

FIG. 6C is a flow chart illustrating in detail an optimal relay node determination process which is executed when receiving a detection response signal addressed to a different node in the procedure illustrated in FIG. 6A;

FIG. 7 is a diagram showing the result of routing an optimal path by the multi-hop radio communication path routing method according to the embodiment;

FIG. 8 is a diagram illustrating another exemplary layout of nodes to which the method of the present invention can be applied; and

FIG. 9 is a diagram showing an exemplary structure of optimum parameters.

### DETAILED DESCRIPTION OF THE PREFERRED EMBODIMENTS

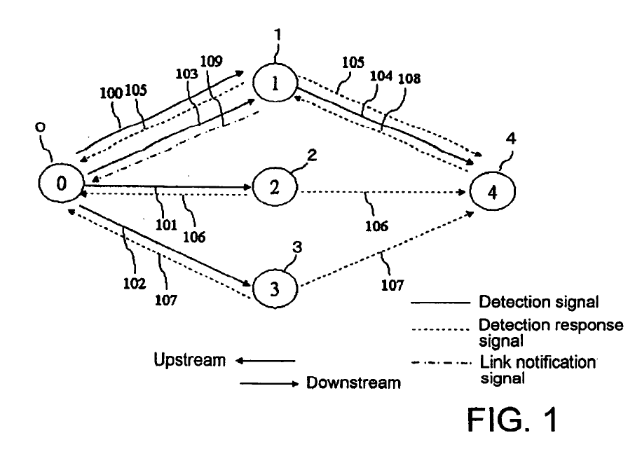

In FIG. 1 which generally describes an optimal relay node selecting method in routing a multi-hop radio communications path based on an embodiment of the present invention, a multi-hop radio communications network comprises base node 0, and nodes 1 to 4. Base node 0 is assigned identification number (ID) ID0, while nodes 1 to 4 are assigned ID1 to ID4, respectively. Base node 0 centrally controls the multi-hop radio communications network, and also operates as a base station for nodes 1 to 4.

Base node 0, which is also called “centralized control unit/base station,” is distinguished from ordinary nodes 1 to 4.

In this multi-hop radio communications network, detection signals 100 to 104, detection response signals 105 to 108, and link notification signal 109 are transmitted and received between nodes for routing a path. In the embodiment, assume that nodes 1 to 4 are all driven by batteries, and the remaining battery level in each node is also taken into consideration in routing a path, such that at least a node having a small remaining battery level is not selected as a relay node. Of course, some of nodes may be driven by a commercial power source, in which case such nodes may be regarded as having 100% of remaining battery level at all times.

First, these signals are defined.

The detection signal is a signal used to detect whether a path can be established from an upstream node to a downstream node immediately therebelow in order to establish a multi-hop radio communication path therebetween, and is transmitted to nodes 1 to 4. Here, an upstream node which transmits the detection signal is called the “detecting node,” while a downstream node immediately therebelow is called the “detected node.” The detecting node is either base node 0 or a node to which a path has been already established from base node 0. At the first stage of the path establishment, base node 0 alone transmits the detection signal. The detection signal is transmitted from the detecting node to a detected node. Upon transmission of the detection signal, base node 0 determines which node is chosen to be a detecting node, when base node 0 is not the detecting node, and which node is chosen to be a detected node. After the determination, base node 0 transmits the detection signal to the detected node. When a certain node is chosen to be a detecting node, the detection signal is transferred to the certain node which should serve as the detecting node through a previously established path.

The detection response signal is a signal transmitted by a detected node, which has received the detection signal, in order to return a response to the detection signal. The detected node receives the detection signal from a detecting node, and transmits the detection response signal to the detecting node if a predetermined criterion is satisfied. This criterion for transmission will be described later.

Due to the broadcasting nature of radio communications, i.e., since radiowaves used in radio communications tend to propagate widely in various directions, radiowaves including the detection response signal can reach nodes other than a destination node. When the detection response signal is received by a node which is not a detecting node, the node which has received the detection response signal holds information on a source node of the detection response signal (i.e., the detecting node) as information on an optimal relay node if a certain criterion is satisfied. This criterion will be also described later.

The link notification signal is a signal for notifying base node Q that each node has been detected so that a path has been established. When a detecting node receives a detection response signal from a detected node, the detecting node transmits the link notification signal to base node 0 for notifying base node 0 that a path has been established by the detected node. Also, optimal relay node information is communicated to base node 0 through the link notification signal.

Next, a description will be given of the number of hops in this embodiment. While the following description employs terms “the number of hops of a detecting node” and “the number of hops of a detected node,” the number of hops for a certain node, as used in this embodiment, indicates the number of hops required for arrival from the base node to this node. Therefore, when a detecting node is base node 0, the number of hops of the detecting node is zero. The number of hops is one for a node directly connected to base node 0, the number of hops is two for a node connected to base node 0 with one relay node interposed therebetween, and so forth.

The following description will be given of signals transmitted and received by each node in the example illustrated in FIG. 1.

Base band 0 transmits detection signals 100, 103 to node 1 over the air, and transmits detection signals 101, 102 to nodes 2, 3 over the air, respectively. Also, base node 0 receives detection response signals 105 to 107 from nodes 1 to 3, respectively, and receives link notification signal 109 from node 1.

Node 1 transmits detection signal 104 to node 4 over the air, and receives detection response signal 108 from node 4. Node 1 transmits detection response signal 105 to base node 0 in response to detection signal 100 received from base node 0, and transmits link notification signal 109 to base node 0 in response to detection response signal 108 received from node 4, as will be later described.

Nodes 2, 3 transmit detection response signals 106, 107, respectively, over the air in response to received detection signals 101, 102.

Node 4 receives detection signal 104 from node 1, and transmits detection response signal 108. Also, upon receipt of detection response signals 105 to 107 transmitted from nodes 1 to 3 to base node 0, respectively, node 4 holds information on an optimal one of nodes 1 to 3 as a relay node. Further, upon transmission of the aforementioned detection response signal 108, node 4 transmits information which has been held therein until node 4 itself is detected by detection signal 104, included in detection response signal 108.

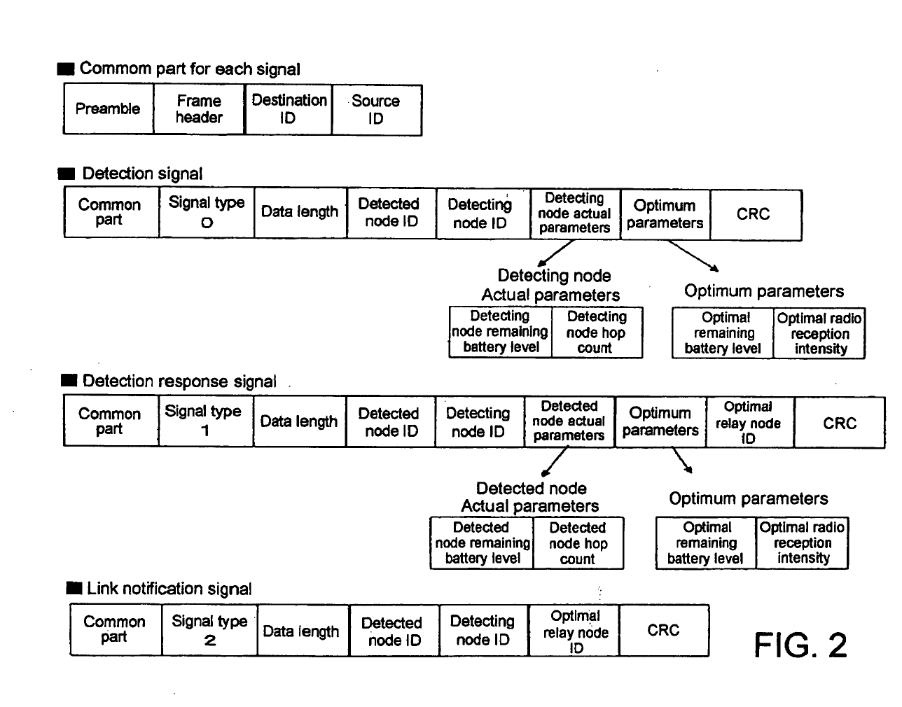

FIG. 2 shows exemplary frame formats of the detection signal, detection response signal, and link notification signal. Since the first parts of the detection signal, detection response signal, and link notification signal are common to these signals, the structure of this common part will be first described.

The common part is made up of fields of a preamble, a frame header, a destination ID, and a source ID. The preamble is provided for establishing the synchronization between transmission and reception of a radio signal. The frame header indicates the front end of the frame. The source ID and destination ID fields store a destination node ID and a source node ID, respectively, involved in a hop-by communication of a radio signal.

The last part of either of the detection signal, detection response signal, and link notification signal is a CRC (Cyclic Redundancy Check) field used to identify errors in communication.

Next, a description will be given of the configuration of fields in each signal. A signal type field in each signal indicates the type of the signal, where “0” indicates a detection signal; “1” a detection response signal; and “2” a link notification signal.

In the detection signal, the common part and the signal type field are followed by fields of a data length, a detected node ID, a detecting node ID, detecting node actual parameters, and optimum parameters, with the CRC field appended at the end. The data length field indicates the amount of data from the detecting node ID to the optimum parameters before the CRC. The detected node ID field indicates the ID of a detected ID. The detecting node ID field indicates the ID of a detecting ID. The detecting node actual parameters indicate the actual remaining battery level in the detecting node, and the number of hops from base node 0 to the detecting node. In the following, the actual remaining battery level in the detecting node is called the “detecting node remaining battery level,” and the number of hops from base node 0 to the detecting node is called the “detecting node hop count.” The optimum parameters indicate an optimal remaining battery level and an optimal radio reception intensity, distributed from base node 0 as optimal reference values. Here, the optimal remaining battery level is represented by a lower limit value for the remaining battery level in the detecting node, and the optimal radio reception intensity is represented by a lower limit value for the radio reception intensity when the detected node receives the detection signal over the air.

In the detection response signal, the common part and signal type parameter are followed by fields of a data length, a detected node ID, a detecting node ID, detected node actual parameters, optimum parameters, and optimal relay node ID, with the CRC field appended at the end. Here, the data length field, detected node ID field, detecting node ID field, and optimum parameters are similar to those of the detection signal. The detected node actual parameters indicate a detected node remaining battery level, and a detected node hop count. The detected node remaining battery level refers to the actual remaining battery level in the detected node, and the detected node hop count refers to the number of hops from base node 0 to the detected node. The optimal relay node ID field stores the ID of an optimal relay node for each node in order to notify base node 0 of such a relay node.

In the link notification signal, the common part and signal type field are followed by fields of a data length, a detected node ID, a detecting node ID, and a optimal relay node ID, with the CRC field appended at the end. Each of these fields is similar to that of the detection response signal.

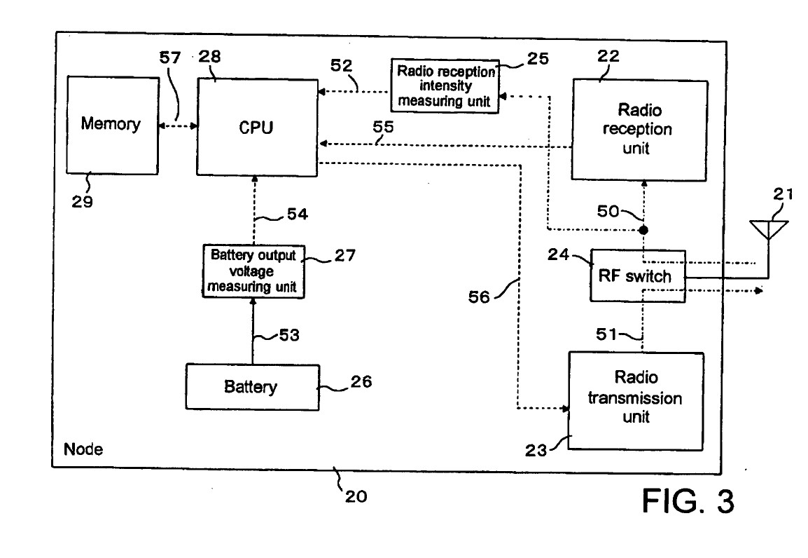

Next, the configuration of each node 1 to 4 will be described. FIG. 3 illustrates an exemplary configuration of the node, where the configuration of nodes 1 to 4 is represented by node 20 for illustration.

Node 20 comprises antenna 21, radio reception unit 22, radio transmission unit 23, RF switch 24, radio reception intensity measuring unit 25, battery 26, battery output voltage measuring unit 27, CPU 28, and memory 29.

Antenna 21 receives radiowaves transmitted from other nodes from the space (i.e., in the air), and radiates radiowaves in the space toward other nodes. Radio reception unit 22 demodulates received radio signal 50 received from antenna 21, and converts the demodulated signal to a digital signal which is supplied to CPU 28 as received data 55. Here, received radio signal 50 is a modulated analog signal including a communication signal from another node, and therefore, received data 55 includes a digital signal transferred from the other node. Radio transmission unit 23 converts a digital signal, which is supplied from CPU 28 for transfer to another node, to radio transmission signal 51 which is supplied to antenna 21. In FIG. 3, the digital signal supplied from CPU 28 for transfer to another node is represented by transmission data 56. Radio transmission signal 51 is a modulated analog signal including a communication signal addressed to another node. RF switch 24 switches a signal transmission path from antenna 21 either to radio reception unit 22 or to radio transmission unit 23.

Radio reception intensity measuring unit 25 measures the field intensity of received radio signal 50 received by antenna 21, and supplies CPU 28 with a digital value indicative of the measured result as radio reception intensity data 52. Battery 26 is a power supply for operating the respective components of node 20. Battery output voltage measuring unit 27 measures battery output voltage 53, i.e., a voltage varied in accordance with the remaining battery level and delivered by battery 26, and supplies CPU 28 with battery output voltage data 54 which is a digital value converted from measured battery output voltage 53.

CPU 28 makes a determination relating to the radio reception intensity based on radio reception intensity data 52 supplied from radio reception intensity measuring unit 25; makes a determination relating to a remaining battery level based on battery output voltage data 54 supplied from battery output voltage measuring unit 27; performs certain processing based on received data 55 supplied from radio reception unit 22; and supplies transmission data 56 to radio transmission unit 23 for transferring the result of the processing to other nodes. Memory 29 holds data 57 supplied thereto in response to a request from CPU 28 in a write operation, and delivers data 57 held therein in response to a request from CPU 28 in a read operation.

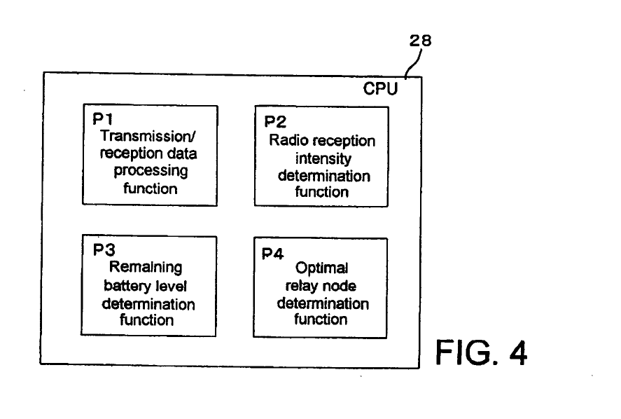

FIG. 4 illustrates main functions of CPU 28 which are divided from a logical viewpoint. CPU 28 comprises transmission/reception data processing function P1, radio reception intensity determination function P2, remaining battery level determination function P3, and optimal relay node determination function P4. Transmission/reception data processing function P1 comprises functions involved in analyzing a digital signal supplied from radio reception unit 22, i.e., received data 55, then performing certain processing on received data 55, and supplying a transmission digital data, i.e., transmission data 56 to radio transmission unit 23 for transferring the result of the processing to another node. Radio reception intensity determination function P2 comprises a function for performing determination relating to the radio reception intensity based on radio reception intensity data 52 supplied from radio reception intensity measuring unit 25. Remaining battery level determination function P3 comprises a function for performing determination relating to a remaining battery level based on battery output voltage data 54 supplied from battery output voltage measuring unit 27. Optimal relay node determination function P4 comprises a function for performing determination relating to the selection of an optimal relay node based on information such as the ID, radio reception intensity, remaining battery level, and number of hops.

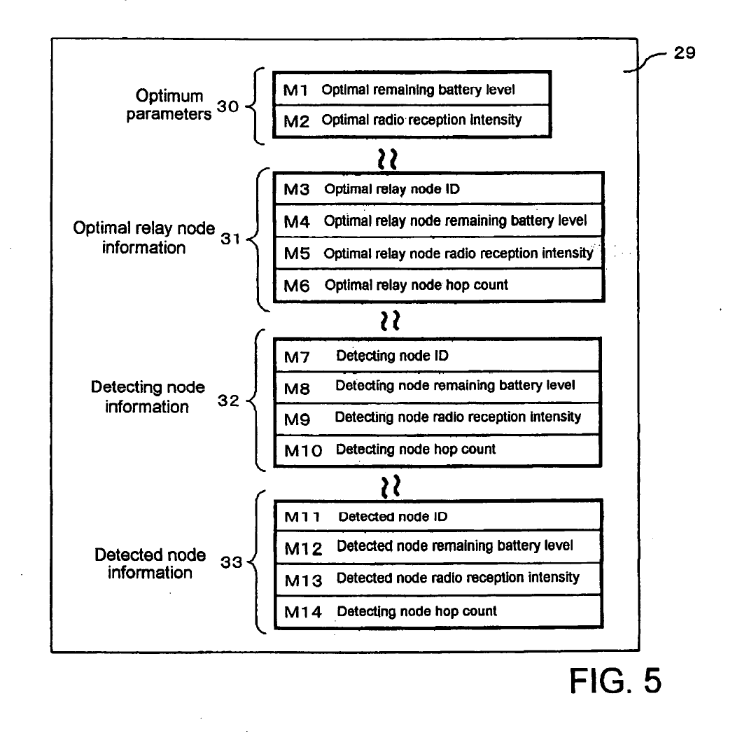

FIG. 5 describes which information is written into and read from memory 29 by CPU 28. As shown in FIG. 5, optimum parameters 30, optimal relay node information 31, detecting node information 32, and detected node information 33 are stored in memory 29 by CPU 28. Among them, optimum parameters 30 comprise optimal remaining battery level M1, and optimal radio reception intensity M2. Optimal relay node information 31 comprises optimal relay node ID M3, optimal relay node remaining battery level M4, optimal relay node radio reception intensity M5, and optimal relay node hop count M6. Detecting node information 32 comprises detecting node ID M7, detecting node remaining battery level M8, detecting node radio reception intensity M9, and detecting node hop count M10. Detected node information 33 comprises detected node ID M11, detected node remaining battery level M12, detected node radio reception intensity M13, and detected node hop count M14.

Since node 20 is provided with CPU 28 and memory 29 as described above, node 20 can be implemented by loading a computer program for implementing the node into a computer including a CPU and causing the CPU to execute the program. Such a program is read into the computer through a recording medium such as a CD-ROM or through a network. As the CPU executes such a program, CPU 28 implements the aforementioned transmission/reception data processing function P1, radio reception intensity determination function P2, remaining battery level determination function P3, and optimal relay node determination function P4, thereby permitting the computer to function as the aforementioned node 20.

Next, a description will be given of the operation of an optimal relay node selecting method in this embodiment.

First, base node 0 transmits the optimum parameters, in a form included in the detection signal as shown in FIG. 2, to each node. Generally, the optimum parameters are programmably set by a user in base node 0 such that uniform values are distributed to each node as the optimum parameters. Once the optimum parameters are set, the same optimum parameters are distributed in a subsequent path re-routing operation each time a detection signal is transmitted. Alternatively, the user may set different optimum parameters to respective nodes, such that base node 0 transmits these optimum parameters. As mentioned above, the optimum parameters comprise the optimal remaining battery level and optimal radio reception intensity, where the optimal remaining battery level indicates a minimum remaining battery level required by a detecting node, and the optimal radio reception intensity indicates a minimum radio reception intensity which permits a detected node to determine that the detected node can correctly receive a detection signal transmitted from a detecting node when the detected node receives the detection signal.

Also, each detecting node transmits detecting node actual parameters, in a form included in the detection signal as shown in FIG. 2, to other nodes. The detecting node actual parameters include an actual remaining battery level and the number of hops (i.e., hop count) of the associated node (i.e., detecting node), wherein, as mentioned above, the number of hops is zero when the detecting node is base node 0, so that the number of hops is set to zero, as contained in the detection signal transmitted from base node 0. Then, the number of hops is one for a node directly connected to base node 0, the number of hops is two for a node connected to base node 0 with one relay node interposed therebetween, and so forth. It should be noted that since the node consumes electric power for path re-routing, radio transmission/reception and the like, the remaining battery level can be reduced. Also, the number of hops of each node can also change because a previously routed path is likely to change.

Upon receipt of the detection signal as described above, each node transmits a detection response signal including detected node actual parameters and optimum parameters. The optimum parameters included in the detection response signal are the same as the optimum parameters included in the detection signal, so that a node, which has received the detection signal, reads the optimum parameters included therein, and transmits the detection response signal which includes the same optimum parameters. Also, the detected node actual parameters include an actual remaining battery level and the number of hops (i.e., hop count) of the detected node. The number of hops in the detected node actual parameters is defined in a similar manner to the number of hops of the detecting node.

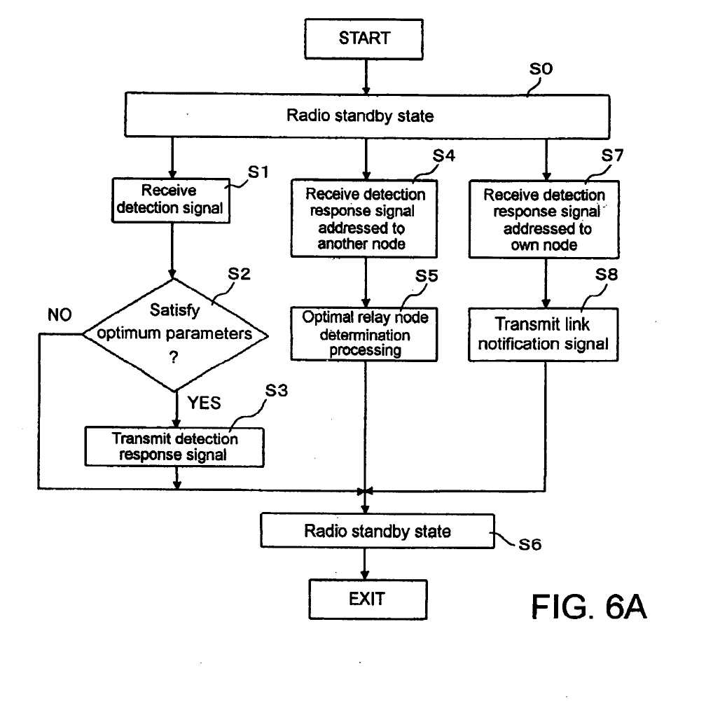

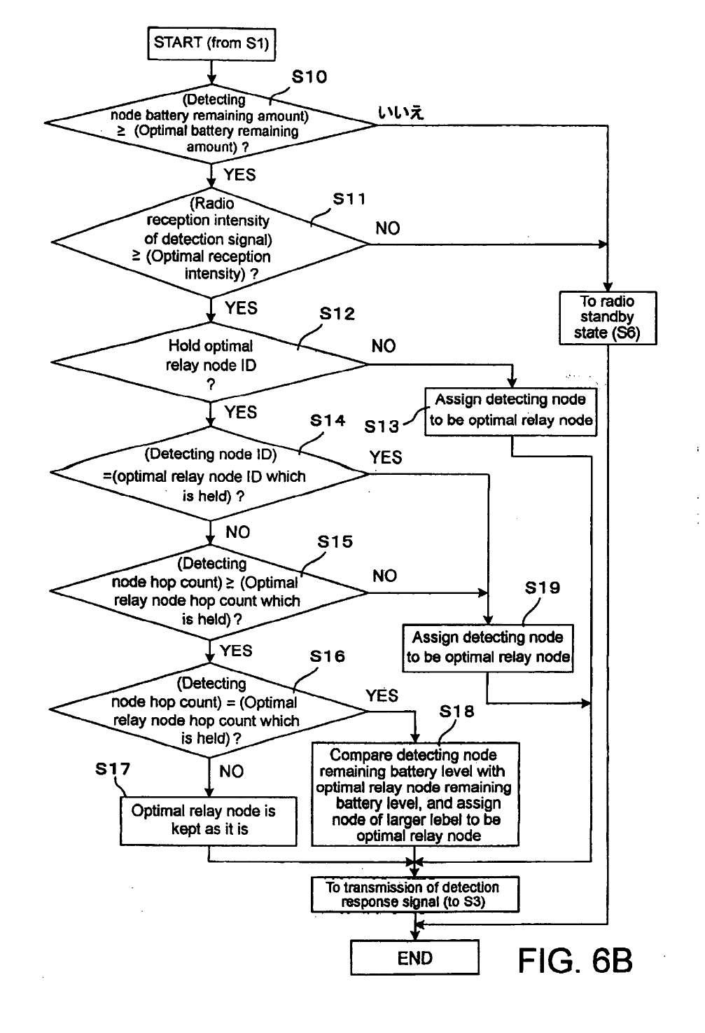

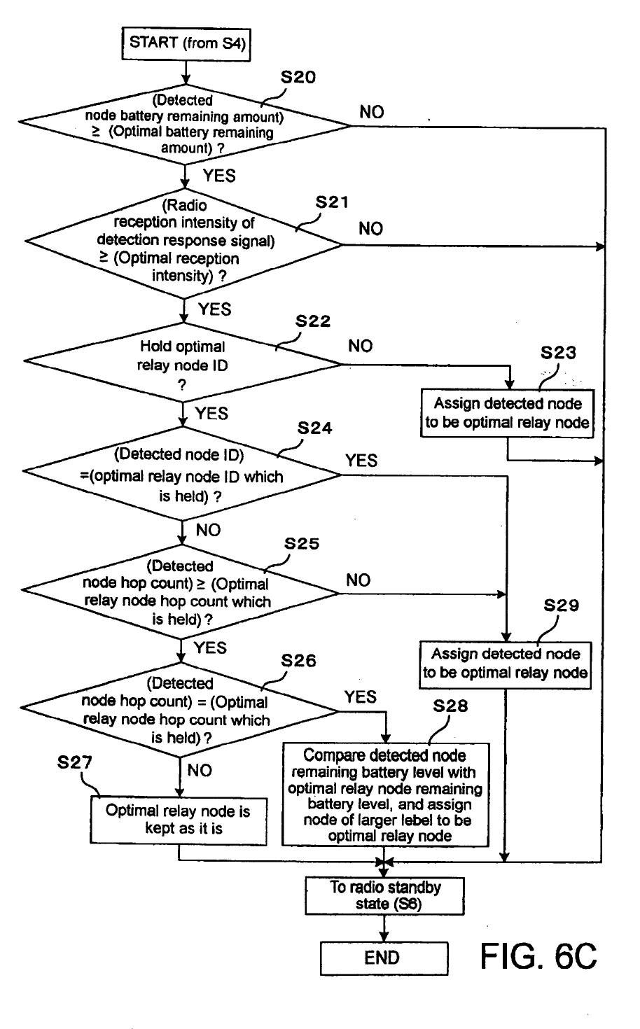

FIG. 6A illustrates a path routing procedure which employs the optimal relay node selecting method of this embodiment.

As each node is powered on, each node enters a radio standby state in which the node waits incoming radio signal at step S0. When a node in the standby state receives a detection signal addressed thereto at step S1, the node determines whether or not the optimum parameters are satisfied, as shown in step S2. Though details are described later, when the node determines at step S2 that the optimum parameters are satisfied, the procedure goes to step S3, where the node transmits a detection response signal, followed by a transition to step S6, where the node enters the radio standby state again. When the node determines at step S2 that the optimum parameters are not satisfied, the procedure directly goes to step S6, where the node enters the radio standby state.

As illustrated in FIG. 6B, at step S2 where a determination is made as to whether or not the optimum parameters are satisfied, the detecting node remaining battery level included in the detecting node actual parameters of the detection signal is compared with the optimal remaining battery level included in the optimum parameters at step S10. Here, if the detecting node remaining battery level is smaller than the optimal remaining battery level, the optimum parameters are not satisfied, causing the procedure to return step S6, where the node enters the radio standby state, without performing anything. Conversely, if the detecting node remaining battery level is equal to or larger than the optimal remaining battery level at step S10, the procedure goes to step S11.

At step S11, the radio reception intensity at the detected node of the detection signal transmitted from the detecting node is compared with the optimal radio reception intensity included in the detection signal. Here, if the radio reception intensity of the detection signal is lower than the optimal radio reception intensity, the optimum parameters are not satisfied, causing the procedure to return to step S6, where the node enters the radio standby state, without performing anything. On the other hand, if the radio reception intensity of the detection signal is equal to or higher than the optimal radio reception intensity at step S11, the procedure goes to step S12.

At step S12, it is confirmed whether or not the detected node holds the optimal relay node information. If the detected node does not hold the optimal relay node information, the procedure goes to step S13, whereas if holds, the procedure goes to step S14. At step S13, the detecting node which has transmitted the previous detection signal is assigned to be an optimal relay node, and the ID, actual remaining battery level, actual radio reception intensity, the number of hops of the detecting node are held in the node itself (i.e., the detected node). Subsequently, the procedure goes to step S3, where the detection response signal is transmitted. Particularly, the ID of the detecting node is held as an optimal relay node ID.

At step S14, the detecting node ID included in the detection signal is compared with the optimal relay node ID held in the detected node. When the ID's are different, the procedure goes to step S15, whereas when the ID's are the same, the procedure goes to step S19, where the detecting node is assigned to be an optimal relay node, followed by a transition to step S3, where the detection response signal is transmitted.

At step S15, the detecting node hop count included in the detection signal is compared with the optimal relay node hop count held in the detected node. If the number of hops of the detecting node (i.e., detecting node hop count) is equal to or larger than the number of hops of the optimal relay node (i.e., optimal relay node hop count), the procedure goes to step S16. Conversely, if the number of hops of the detecting node is smaller than the number of hops of the optimal relay node, the procedure goes to step S19, where the detecting node is newly assigned to be an optimal relay node, and information relating to the detecting node is held in the detected node, followed by a transition to step S3, where the detection response signal is transmitted. Here, the information relating to the detecting node includes the node ID, remaining battery level, radio reception intensity, and the number of hops.

At step S16, it is confirmed whether the detecting node hop count included in the detection signal is equal to the optimal relay node hop count which is held in the detected node. When equal, the procedure goes to step S18; whereas when not equal, the procedure goes to step S17, where the optimal relay node ID held in the detected node is kept therein as it is, followed by a transition to step S3, where the detection response signal is transmitted.

At step S18, the detecting node remaining battery level included in the detection signal is compared with the remaining battery level of the optimal relay node held in the detected node, and the node having a larger remaining battery level is assigned to be an optimal relay node, and the ID of the optimal relay node is held in the detected node. If the remaining battery levels are the same, the detecting node is assigned to be an optimal relay node. Subsequently, the detection response signal is transmitted at step S3.

The foregoing description has been given of the processing at step S2 at which the detected node receives the detection signal and determines whether or not the optimum parameters are satisfied.

The detection response signal transmission processing at step S3 involves transmitting a detection response signal in response to the detection signal received at the detected node when the received detection signal satisfies the optimum parameters. In this event, the optimal relay node ID, which has been stored in the detected node, is written into the optimal relay node ID field of the detection response signal. For example, when the procedure goes from step S13 to step S3, the detecting node ID held in the detected node at step S13 is written into the optimal relay node ID field of the detection response signal. The actual remaining battery level of the detected node, and the number of hops of the detected node are written into the detected node actual parameters of the detection response signal. The values of the optimum parameters contained in the transmitted detection signal are written into the optimum parameters in the detection response signal as they are. In the foregoing manner, after writing an appropriate value into each field of the detection response signal, the detected node transmits the detection response signal to the detecting node. After transmitting the detection response signal, the detected node returns to the radio standby state at step S6.

The foregoing description has been given of the flow of operations performed when the detection signal is received.

Next, a description will be given of operations performed when a certain node receives a detection response signal addressed to another node. It can be found whether a detection response signal is addressed to the node itself or to another node by examining whether or not the detected node ID in the detection response signal is the ID of the node itself or the ID of another node.

When a particular node, which is in a radio standby state at step S0, receives a detection response signal addressed to another node, the node executes optimal relay node determination processing at step S5, and then goes to step S6, where the node enters the radio standby state. FIG. 6C is a flow chart illustrating the optimal relay node determination processing in detail.

First, at step S20, a detected node remaining battery level included in the detection response signal is compared with the optimal remaining battery level in the optimum parameters. If the detected node remaining battery level is equal to or larger than the optimal remaining battery level, the flow goes to step S21, whereas if the detected node remaining battery level is smaller than the optimal remaining battery level, the flow goes to step 86, where the node enters the radio standby state, without performing anything. At step S21, a radio reception intensity when the detection response signal was actually received from the detected node is compared with the optimal radio reception intensity included in the optimum parameters of the detection response signal. If the actual radio reception intensity is equal to or higher than the optimal radio reception intensity, the flow goes to step S22, whereas if the actual radio reception intensity is lower than the optimal radio reception intensity, the flow goes to step S6, where the node enters the radio standby state, without performing anything. The detected node, herein referred to, is another node which has transmitted the detection response signal, when viewed from the particular node which has received the detection response signal.

At step S22, it is confirmed whether or not the node itself has held optimal relay node information. If held, the flow goes to step S24. If not held, the node which transmitted the detection response signal, i.e., a node represented by the detected node ID in the detection response signal, is assigned to be an optimal relay node, and the node ID, actual remaining battery level, actual radio reception intensity, and the number of hops of the detected node are held in the node itself, followed by a transition to step S6, where the node enters the radio standby state.

At step S24, the detected node ID included in the detection response signal is compared with the optimal relay node ID held in the node itself. If these ID's are different, the flow goes to step S25, whereas if the ID's are the same, the detected node is assigned to be an optimal relay node as it is at step S29, followed by a transition to step S6 where the node enters the radio standby state.

At step S25, the detected node hop count included in the detection response signal is compared with the optimal relay node hop count held in the node itself. If the detected node hop count is equal to or larger than the optimal relay node hip count, the flow goes to step S26. If the detected node hop count is smaller than the optimal relay node hop count, as determined at step S25, the flow goes to step S29, where the detected node is newly assigned to be an optimal relay node, and information relating to this node is held in the node itself, followed by a transition to step S6, where the node enters the radio standby state. The information relating to the optimal relay node includes the node ID, remaining battery level, radio reception intensity, and number of hops.

At step S26, it is confirmed whether or not the number of hops of the detected node is equal to the number of hops of the optimal relay node held in the node itself. If equal, the flow goes to step S28, whereas if not equal, the flow goes to step S27, where the optimal relay node held in the node itself is held as it is, followed by a transition to step S6, where the node enters the radio standby state.

At step S28, the detected node remaining battery level included in the detection response signal is compared with the optimal node remaining battery level held by the node itself. The node having a larger remaining battery level is assigned to be an optimal relay node, and the ID of the optimal relay node is held in the node itself. When both the remaining battery levels are equal, the detected node is assigned to be an optimal node, followed by a transition to step S6, where the node enters the radio standby state.

The foregoing description has been given of the optimal relay node determination processing at step S5 when a node receives a detection response signal addressed to another node. Next, a description will be given of operations performed when a certain node receives a detection response signal addressed to the node itself. Whether a detection response signal is addressed to the node itself or another node can be found, as mentioned above, by examining whether or not the detected node ID in the detection response signal is the ID of the node itself or the ID of another node. A node receives a detection response signal addressed to the node itself from a certain detected node when the node itself has transmitted a detection signal to the detected node. In this embodiment, any node except for base node 0 does not transmit the detection signal unless it is so instructed from base node 0, and in order that such an instruction is communicated to a node, a path must have been established from base node 0 to the node.

When a node, which is in the radio standby state at step SO, receives a detection response signal addressed thereto at step S7, the node transmits a link notification signal to base node 0 through a previously established path at step S8, followed by a transition to step S6, where the node enters the radio standby state. In this event, an optimal relay node ID in the link notification signal stores a value held in the optical relay node ID field of the received detection response signal addressed to the node itself, and a detected node ID also stores the ID of the node which transmitted the detection response signal addressed to the received node itself.

When the node has the configuration illustrated in FIG. 5, the foregoing path routing procedure can be described as follows, including operations performed by CPU 28.

Assume that node 20, which is in the radio standby state, receives a detection signal addressed thereto. When node 20 receives the detection signal at step S1, received data 55 includes an optimal remaining battery level, an optimal radio reception intensity, a detecting node ID, a detecting node remaining battery level, and a detecting node hop count. Therefore, CPU 28 executes received data processing to store these values in memory 29. Specifically, CPU 28 holds the optimal remaining battery level and optimal radio reception intensity included in the detection signal in optimal remaining battery level M1 and optimal radio reception intensity M2 of optimum parameters 30 in memory 29, and holds the detecting node ID, detecting node remaining battery level, and detecting node hop count included in the detection signal in detecting node ID M7, detecting node remaining battery level M8, and detecting node hop count M10, respectively, of detecting node information 32. Also, when the detection signal is received, CPU 28 acquires the radio reception intensity of the detection signal from radio reception intensity data 52, and holds it in detecting node radio reception intensity M9 of detecting node information 32 in memory 29.

After holding the information, CPU 28 reads optimal remaining battery level Ml and detecting node remaining battery level M8 from memory 29 to compare one with the other in order to determine at step S10 whether or not the detecting node remaining battery level is equal to or larger than the optimal remaining battery level. If the result of this comparison shows that detecting node remaining battery level M8 is equal to or larger than optimal remaining battery level M1, CPU 28 reads optimal radio reception intensity M2 and detecting node radio reception intensity M9 from memory 29 to compare one with the other in order to determine at step S11 whether or not the detecting node radio reception intensity is equal to or higher than the optimal radio reception intensity. If the result of this comparison shows that detecting node radio reception intensity M9 is equal to or higher than optimal radio reception intensity M2, CPU 28 confirms at step S12 whether or not information relating to the optimal relay node has been held in optimal relay node information 31 in memory 29.

When information relating to the optimal relay node has not been held, CPU 28 writes the information held in detecting node information 32 (i.e., detecting node ID M7, detecting node remaining battery level M8, detecting node radio reception intensity M9, detecting node hop count M10) in memory 29 into optimal relay node ID M3, optimal relay node remaining battery level M4, optimal relay node radio reception intensity M5, and optimal relay node hop count M6, as they are, in order to assign the detecting node to be an optimal relay node at step S13. After writing the information, CPU 28 reads optimal remaining battery level M1, optimal radio reception intensity M2, and optimal relay node ID M3 from memory 29, and transmits them, as included in a detection response signal, to the detecting node at step S3. In this event, CPU 28 also includes the remaining battery level and the number of hops of node 20 itself in the detection response signal as detected node actual parameters.

When information relating to the optimal relay node has been held, as determined at step S12, CPU 28 reads optimal relay node ID M3 and detecting node ID M7 from memory 29 to compare one with the other in order to determine at step S14 whether or not the held optimal relay node ID is the same as the detecting node ID. If the result of the comparison shows that the ID's are the same, CPU 28 writes detecting node information 32 into optimal relay node information 31 at step S19, in a manner similar to step S13, and transmits the detection response signal at step S3 in a manner similar to the foregoing.

If the result of the comparison at step S14 shows that the ID's are different, CPU 28 reads optimal relay node hop count M6 and detecting node hop count M10 from memory 29 to compare one with the other in order to compare the number of hops of the detecting node with the number of hops of the optimal relay node at steps S15 to S16. If the result of the comparison shows that the detecting node hop count is smaller than the optimal relay node hop count, CPU 28 writes detecting node information 32 into optimal relay node information 31 at step S19, in a manner similar to step S13, and transmits the detection response signal at step S3 in a manner similar to the foregoing. If the result of the comparison shows that the numbers of hops are equal, CPU 28 reads optimal relay node remaining battery level M4 and detecting node remaining battery level M8 from memory 29 in order to compare the remaining battery level of the detecting node with the remaining battery level of the optimal relay node at step S18. Then, CPU 28 newly assigns the node having a larger remaining battery level to be an optimal relay node, and writes information relating to this node into optimal relay node information 31 in memory 29. Subsequently, CPU 28 transmits the detection response signal at step S3 in a manner similar to the foregoing. If the number of hops of the detecting node is larger than the number of hops of the optimal relay node, CPU 28 leaves the optimal relay node held therein as it is at step S17, and transmits the detection response signal at step S3 in a manner similar to the foregoing.

Assume that node 20, which is in a radio standby state, receives a detection response signal addressed to another node. When node 20 receives the detection response signal addressed to another node at step S4, received data 55 includes an optimal remaining battery level, an optimal radio reception intensity, a detected node ID, a detected node remaining battery level, and a detected node hop count. The detected ID included herein is the ID of a node which transmitted the detection response signal. Therefore, CPU 28 executes the received data processing to store these values in memory 29. Specifically, CPU 28 holds the optimal remaining battery level and optimal radio reception intensity included in the detection reception signal in optimal remaining battery level Ml and optimal radio reception intensity M2 of optimum parameters 30 in memory 29, respectively, and holds the detected node ID, detected node remaining battery level, and detected node hop count included in the detection response signal in detected node ID M11, detected node remaining battery level M12, and detected node hop count M14 of detected node information 33, respectively. Also, when the detection response signal is received, CPU 28 acquires the radio reception intensity of the detection response signal from radio reception intensity data 52, and holds this radio reception intensity in detected node radio reception intensity M13 of detected node information 33 in memory 29.

After holding the information, CPU 28 reads optimal remaining battery level M1 and detected node remaining battery level M12 from memory 29 to compare one with the other in order to determine at step S20 whether or not the detected node remaining battery level is equal to or larger than the optimal remaining battery level. If the result of the comparison shows that the detected node remaining battery level M12 is equal to or larger than optimal remaining battery level M1, CPU 28 reads optimal radio reception intensity M2 and detected node radio reception intensity M13 from memory 29 for comparison in order to determine at step S21 whether or not the detected node radio reception intensity is equal to or higher than the optimal radio reception intensity. If the result of the comparison shows that detected node radio reception intensity M13 is equal to or higher than optimal radio reception intensity M2, CPU 28 confirms at step S32 whether or not information relating to an optimal relay node has been already held in optimal relay node information 31 in memory 29.

If information relating to an optimal node has not been held, CPU 28 writes the information held in detected node information 33 in memory 29, as it is, into optimal relay node information 31 in a manner similar to step S13 in order to assign the detected node to be an optimal relay node at step S23. Subsequently, node 20 returns to the radio standby state, as shown in step S6.

If information relating to an optimal relay node has been held, as determined at step S22, CPU 28 reads optimal relay node ID M3 and detected node ID M1 from memory 29 to compare one with the other in order to determine at step S24 whether or not the optimal relay node ID is the same as the detected node ID. If the result of the comparison shows that the ID's are the same, CPU 28 writes detected node information 33 into optimal relay node information 31 at step S29 in a manner similar to step S23. Subsequently, node 20 returns to the radio standby state, as shown in step S6.

If the result of the comparison at step S24 shows that the ID's are different, CPU 28 reads optimal relay node hop count M6 and detected node hop count M14 from memory 29 for comparison in order to compare the number of hops of the detected node with the number of hops of the optimal relay node at steps S25 to S26. If the number of hops of the detected node is smaller than the number of hops of the optimal relay node, CPU 28 writes detected node information 33 into optimal relay node information 31 at step S29 in a manner similar to step S23. Subsequently, node 20 returns to the radio standby state, as shown in step S26.

If the number of hops of the detected node is equal to the number of hops of the optimal relay node, CPU 28 reads optimal relay node remaining battery level M4 and detected node remaining battery level M12 from memory 29 in order to compare the remaining battery level in the detected node with the remaining battery level in the optimal relay node held in node 20. Then, at step S28, CPU 28 newly assigns the node having the larger remaining battery level to be an optimal relay node, and writes information relating to this node into optimal relay node information 31 in memory 29. Subsequently, node 20 returns to radio standby state, as shown in step S6. If the number of hops of the detected node is larger than the number of hops of the optimal relay node, CPU 28 leaves the held optimal relay node as it is at step S27, and node 20 returns to the radio standby state, as shown in step S6.

Next, a path routing procedure based on this embodiment will be specifically described, giving the multi-hop radio communications network shown in FIG. 1 as an example.

Prior to the routing of a path, assume that base node 0 has been previously registered with identification numbers ID1 to ID4 of nodes 1 to 4 through which a path is to be routed, and that optimum parameters for each node have been previously set in base node 0. Assume also that this is the first path routing, where each node has not held information relating to an optimal relay node at the initial stage.

First, base node 0 transmits detection signal 100 to node 1 in order to detect node 1. The source ID and detecting node ID in this detection signal 100 are both set to “0” which is the ID of base node ID, while the destination ID and detected node ID are both set to “1” which is the ID of node 1. This detection signal includes a remaining battery level of base node 0 as a detecting node actual parameter, and the optimum parameters include an optimal remaining battery level and optimal radio reception intensity. Node 1 compares a radio reception intensity when it received detection signal 100 with the optimal radio reception intensity, and also compares the remaining battery level in base node 0 with the optimal remaining battery level, and transmits detection response signal 105 to base node 0 if the actual remaining battery level is equal to or larger than the optimal remaining battery level, and the radio reception intensity is equal to or higher than optimal radio reception intensity, respectively.

Also, node 1 had not held optimal relay node information at the time it received detection signal 100. Therefore, node 1 holds the ID, i.e., ID0, remaining battery level, radio reception intensity, and number of hops equal to zero of base node 0 in memory 29 as optimal relay node ID M3, optimal relay node remaining battery level M4, optimal relay node radio reception intensity M5, and optimal relay node hop count M6 of optimal relay node information 31 (see FIG. 5), respectively. Then, for transmitting detection response signal 105, node 1 stores zero in the optimal relay node ID field, and stores the remaining battery level and the number of hops equal to one of node 1 in the detected node remaining battery level field and detected node hop count field of the detected node actual parameters, respectively. As base node 0 receives such detection response signal 105, a path is established between base node 0 and node 1. It should be noted that from the fact that radiowaves are used, detection response signal 105 can be received by nodes other than base node 0.

Next, base node 0 transmits detection signal 101 to node 2, as is the case with node 1, in order to detect node 2. Node 2 can receive detection response signal 105 transmitted by node 1 as described above before node 2 is detected by detection signal 101 from base node 0. Therefore, assuming that node 2 has received detection response signal 105 before it receives detection signal 101, node 2 holds information on node 1 as an optimal relay node if the remaining battery level in node 1 included in detection response signal 105 is equal to or higher than the optimal remaining battery level, and the radio reception intensity when detection response signal 105 was received is equal to or higher than the optimal radio reception intensity, respectively. Subsequently, when node 2 receives detection signal 101, node 2 transmits detection response signal 106 to base node 0 if the remaining battery level and radio reception intensity of base node 0 satisfy the condition, as is the case with node 1. In this event, since the number of hops of base node 0 is zero, while the number of hops of node 1 is one, node 2 selects the one having a smaller number of hops, i.e., base node 0 as an optimal relay node, and stores “0” indicative of base node 0 in the optimal relay node ID field in detection response signal 106, which holds information relating to base node 0 as optimal relay node information.

Next, base node 0 transmits detection signal 102 to node 3, however, node 3 can receive detection response signals 105, 106 from nodes 1, 2, respectively, before node 3 is detected, as is the case with node 2. Therefore, node 3 receives both detection response signals 105, 106, and assigns the node having the larger remaining battery level to be an optimal node, and holds information on this node as optimal relay node information if the remaining battery levels and radio reception intensities associated with nodes 1, 2 are equal to or larger than the optimal remaining battery level and equal to or higher than the optimal radio reception intensity because nodes 1, 2 have the same number of hops equal to one. Subsequently, node 3 receives detection signal 102. If the remaining battery level and radio reception intensity associated with base node 0 are equal to or larger than the optimal remaining battery level and equal to or higher than the optimal radio reception intensity when the node 3 receives detection signal 102, node 3 transmits detection response signal 107 to base node 0. In this event, since base node 0 has the number of hops equal to zero, while nodes 1, 2 have the number of hops equal to one, node 3 selects the one having the smaller number of hops, i.e., base node 0 as an optimal relay node, and holds the information relating to base node 0 as the optimal relay node information. The optimal relay node ID field of detection response signal 107 also stores “0” indicative of base node 0.

Subsequently, base node 0 transmits a detection signal to node 4 in an attempt to detect node 4. Assume herein that node 4 does not transmit a detection response signal to base node 0 because a radio reception intensity is lower than the optimal radio reception intensity when node 4 directly receives the detection signal from base node 0. Since the radio reception intensity becomes lower as the distance between nodes is larger, it is often the case that a node does not satisfy the condition relating to the optimal radio reception intensity.

Therefore, base node 0 attempts to detect node 4 from node 1 to which a path has already been routed from base node 0. For this purpose, base node 0 transmits detection signal 103 to node 1 in order to detect node 4. In this detection signal 103, the source ID is “0” which is the ID of base node 0; the detecting node ID is “1” which is the ID of node 1; the destination ID is “1” which is the ID of node 1; and the detected node ID is “4” which is the ID of node 4. Upon receipt of detection signal 103, node 1 transmits detection signal 104 to node 4 in order to detect node 4. In detection signal 104, the source ID is “1” which is the ID of node 1; detecting node ID is “1” which is the ID of node 1; the destination ID and detected node ID are both “4” which is the ID of node 4; and the detecting node actual parameters store the remaining battery level in node 1 and “1” which is the number of hops of node 1. Here, in this example, node 1 is forced to detect node 4 because base node 0 is programmed to assign those nodes to be detecting nodes along the established path in the order of their ID's, but the present invention is not so limited.

Node 4 can receive detection response signals 105 to 107 transmitted to base node 0 from nodes 1 to 3, respectively, before it receives detection signal 104. Assuming herein that node 4 has already received detection response signals 105 to 107, the node having the largest remaining battery level has been held in node 4 as an optimal relay node, if the remaining battery levels and radio reception intensities associated with nodes 1 to 3 are equal to or larger than the optimal remaining battery level and equal to or higher than the optimal radio reception intensity, because all nodes 1 to 3 have the number of hops equal to one. Assume in the following description that node 2 is held as the optimal relay node.

Upon receipt of detection signal 104, node 4 compares the ID of node 1 with the optimal relay node ID (here “2”) held therein, if the remaining battery level and radio reception intensity associated with node 1 are equal to or larger than the optimal remaining battery level and equal to or higher than the optimal radio reception intensity, respectively. Since the ID of node 1 is different from the optimal relay node ID (here, “2”) held in node 4, node 4 compares the detecting node hop count within detection signal 104 with the optimal relay node hop count. In this event, since the number of hops are both one, node 4 next compares the detecting node remaining battery level with the optimal relay node remaining battery level previously held therein. As mentioned above, here, node 2 has a larger remaining battery level than node 1, so that node 2 still remains to be the optimal relay node. Accordingly, node 4 transmits detection response signal 108, in which optimal relay node ID is set to “2,” to node 1. In this way, a path is established between node 1 and node 4.

Upon receipt of detection response signal 108, node 1 transmits link notification signal 109 to base node 0 through a path, which must have been already established between node 1 and base node 0, to notify base node 0 that the path has been established between nodes 1 and 4. This link notification signal 109 describes node 4 as the detected node, and the ID of node 2, i.e., “2” as the optimal relay node ID.

Base node 0, which has received link notification signal 109 as mentioned above, is notified by this link notification signal that the optimal relay node for node 4 is node 2, and therefore transmits a detection signal to node 2 in order to detect node 4 for detecting node 4 from node 2 to establish a path between node 2 and node 4. Upon receipt of this detection signal, node 2 transmits a detection signal to node 4, and node 4 transmits a detection response signal to node 2. In this way, a path is established between node 2 and node 4.

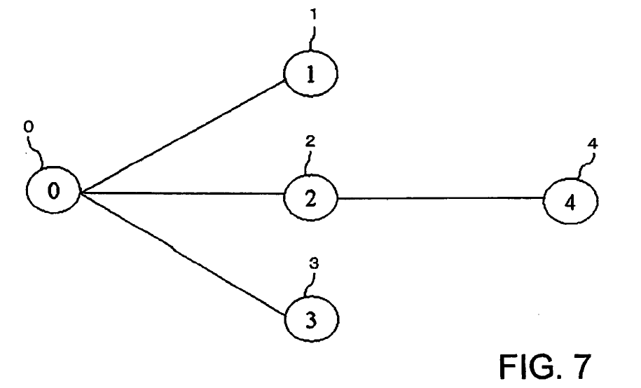

In this way, the optimal relay nodes are selected to complete the path routing, as illustrated in FIG. 7. Here, since either of nodes 1 to 3 has a path which directly connects to base node 0, optimal paths from base node 0 to nodes 1 to 3 are these directly connected paths. On the other hand, the optimal path from base node 0 to node 4 is a path relayed by node 2, as described above.

As described above, in this embodiment, even a node which is not a detected node can determine an optimal relay node by receiving a detection response signal addressed to another node. Thus, it is not necessary to transmit detection signals from all nodes for detecting a certain node, thus improving the efficiency of node detection processing for routing a path. Also, a node holds an optimal relay node ID based on a detection response signal addressed to another node until the node itself is detected, and the node notifies base node 0 of the held optimal relay node ID when the node itself is detected, thereby making it possible to route an optimal path to this node, with only one additional detection required therefor. It is therefore possible, according to the present embodiment, to reduce the number of steps until an optimal path is routed.

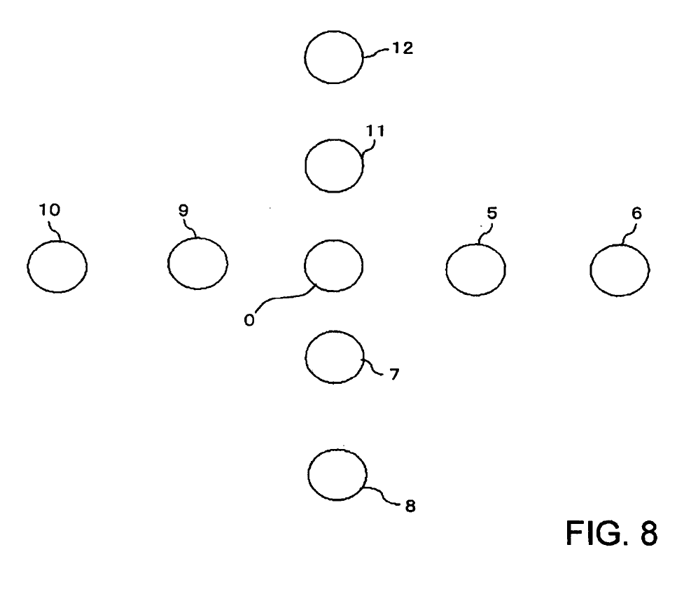

In the multi-hop radio communications network illustrated in FIG. 1, base node 0 is located at an end of an area in which a plurality of nodes are distributed, but the locations of the base node and other nodes are not so limited in the present invention. In a network illustrated in FIG. 8, nodes are radially distributed with respect to base node 0, and the present invention can be applied to such a network topology as well. The location and number of nodes are not limited to those described herein, but a variety of locations and numbers can be employed. Also, the assignment of ID's to nodes is not limited to the one described above.

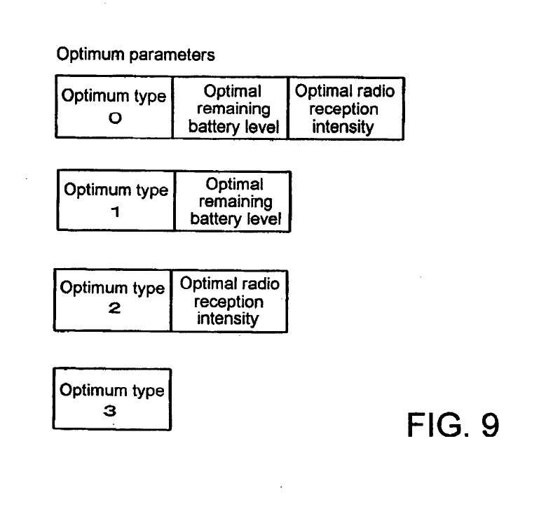

Additionally, in the present invention, an optimum type may be provided in an optimum parameter section in the field formats of the detection signal and detection response signal shown in FIG. 2, so as to permit a selection of an item which Is determined to be an optimal value for establishing a path. For example, it is possible, as shown in FIG. 9, that when the optimum type is set to “0.” a node should provide a remaining battery level equal to or larger than an optimal remaining battery level and a radio reception intensity equal to or higher than an optimal radio reception intensity; when the optimum type is set to “1,” a node should provide a remaining battery level equal to or larger than the optimal remaining battery level; when the optimum type is “2,” a node should provide a radio reception intensity equal to or higher than the optimal radio reception intensity; and when the optimum type is “3,” no comparison is made with the optimum parameters.

A variety of multi-hop networks are contemplated as those which can embody the optimal relay node selecting method in multi-hop radio communications according to the present invention. For example, the method can be applied to a sensor network in which each node is provided with a sensor that can make measurements over a wide geographic area and collect such measured data while an observer is present at a remote site.

Also, the present invention can be applied to a wireless LAN (local area network) hot spot service for expanding a service provision area by configuring a multi-hop radio network with a large number of access points (AP).

While preferred embodiments of the present invention have been described using specific terms, such description is for illustrative purposes only, and it is to be understood that changes and variations may be made without departing from the spirit or scope of the following claims.

What is claimed is:

1. A method of selecting an optimal relay node in a multi-hop radio communications network, comprising the steps of:
receiving, at a particular node, detection response signals which are transmitted from a plurality of other nodes, each of which has received a detection signal, and are not addressed to said particular node; and
selecting a relay node based on the received detection response signals.

2. The method according to claim 1, wherein said detection response signal includes an actual parameter in a node which transmits the detection response signal, and an optimum parameter for use as a criterion for establishing a path, and said particular node selects the relay node from among nodes which have transmitted the detection response signals each having the actual parameter equal to or larger than the optimum parameter.

3. The method according to claim 2, wherein the optimum parameter is compared with the actual parameter in regard to a remaining battery level in the node which has transmitted the detection response signal.

4. The method according to claim 1, wherein said detection response signal includes an optimal radio reception intensity value as an optimum parameter for use as a criterion for establishing a path, and said particular node compares a radio reception intensity when the detection response signal is received with the optimal radio reception intensity value to select said relay node.

5. A method of selecting an optimal relay node in a multi-hop radio communications network, comprising the steps of:
receiving, at a particular node, detection response signals which are transmitted from a plurality of other nodes, each of which has received a detection signal, and are not addressed to said particular node;
preliminarily selecting a relay node for said particular node based on the received detection response signals;
receiving a detection signal for detecting said particular node;
selecting an optimal node by comparing a node which has transmitted said detection signal for detecting said particular node with said preliminarily selected relay node; and
notifying a higher-level node or base node of said selected optimal relay node.

6. The method according to claim 5, wherein said selected optimal relay node is notified to said base node through the detection response signal and a link notification signal from said particular node which serves as a notifying node.

7. The method according to claim 6, wherein said base node forces said optimal relay node to detect said notifying node, when said base node is notified of said optimal relay node, to route an optimal multi-hop radio communications path.

8. The method according to claim 5, wherein:
said detection response signal includes an actual parameter in a node which transmits the detection response signal, and an optimum parameter for use as a criterion for establishing a path;
said detection signal includes an actual parameter in a node which transmits the detection signal, and the optimum parameter;
said particular node preliminary selects said relay node from among nodes which have transmitted detection response signals each having an actual parameter equal to or larger than the optimum parameter; and
said particular node compares the node which has transmitted the detection signal for detecting the particular node with said preliminary selected relay node when the detection signal for detecting the particular node has the actual parameter equal to or larger than the optimum parameter.

9. The method according to claim 8, wherein said selected optimal relay node is notified to said base node through the detection response signal and a link notification signal from said particular node which serves as a notifying node.

10. The method according to claim 9, wherein said base node forces said optimal relay node to detect said notifying node, when said base node is notified of said optimal relay node, to route an optimal multi-hop radio communications path.

11. The method according to claim 8, wherein the optimum parameter is compared with the actual parameter in regard to a remaining battery level in the node which has transmitted the detection response signal.

12. The method according to claim 11, wherein said selected optimal relay node is notified to said base node through the detection response signal and a link notification signal from said particular node which serves as a notifying node.

13. The method according to claim 12, wherein said base node forces said optimal relay node to detect said notifying node, when said base node is notified of said optimal relay node, to route an optimal multi-hop radio communications path.

14. The method according to claim 5, wherein:
said detection response signal includes an optimal radio reception intensity value as the optimum parameter for use as a criterion for establishing a path;
said particular node compares a radio reception intensity when the detection response signal is received with the optimal radio reception intensity value to preliminarily select said relay node; and
said particular node compares a node which has transmitted the detection signal for detecting the particular node with said preliminarily selected relay node when the detection signal is received with a radio reception intensity equal to or higher than the optimal radio reception intensity value.

15. The method according to claim 14, wherein said selected optimal relay node is notified to said base node through the detection response signal and a link notification signal from said particular node which serves as a notifying node.

16. The method according to claim 15, wherein said base node forces said optimal relay node to detect said notifying node, when said base node is notified of said optimal relay node, to route an optimal multi-hop radio communications path.

17. A node which forms part of a multi-hop radio communications network, comprising:
means for receiving detection response signals which are transmitted from a plurality of other nodes, each of which has received a detection signal, and are not addressed to said node; and
means for selecting a relay node based on the received detection response signals.

18. A node which forms part of a multi-hop radio communications network, comprising:
means for receiving detection response signals which are transmitted from a plurality of other nodes, each of which has received a detection signal, and are not addressed to said node, and receiving a detection signal for detecting said node;
means for preliminarily selecting a relay node for said node based on the received detection response signals, and selecting an optimal node by comparing a node which has transmitted said detection signal for detecting said node with said preliminarily selected relay node; and
means for notifying a higher-level node or base node of said selected optimal relay node.

19. A multi-hop radio communications network system comprising;
a base node and a plurality of nodes,
wherein said each node comprises:
means for receiving detection response signals which transmitted from a plurality of other nodes, each of which has received a detection signal, and are not addressed to said node, and receiving a detection signal for detecting said node;
means for preliminarily selecting a relay node for said node based on the received detection response signals, and selecting an optimal node by comparing a node which has transmitted said detection signal for detecting said node with said preliminarily selected relay node; and
means for notifying a higher-level node or base node of said selected optimal relay node from said node which serves as a notifying node, and
wherein said base node comprises means for transmitting the detection signal to said plurality of nodes, and said base node sends the detection signal to said optimal relay node, when said base node is notified of said optimal relay node, to force said optimal relay node to detect said notifying node to route an optimal multi-hop radio communications path.

20. A program for causing a computer provided at a node to execute:
processing for receiving detection response signals which transmitted from a plurality of other nodes, each of which has received a detection signal, and are not addressed to said node; and
processing for selecting a relay node based on the received detection response signals.

21. A program for causing a computer provided at a node to execute:
processing for receiving detection response signals which are transmitted from a plurality of other nodes, each of which has received a detection signal, and are not addressed to said node;
processing for preliminarily selecting a relay node for said node based on the received detection response signals;
processing for receiving a detection signal for detecting said node;
processing for selecting an optimal node by comparing a node which has transmitted the detection signal for detecting said node with said preliminarily selected relay node; and
processing for notifying a higher-level node or base node of said selected optimal relay node.
